(19) United States
(12) Patent Application Publication
(10) Pub. No.: US 2026/0335871 A1
(43) Pub. Date: Oct. 29, 2026

(54) CATALYSTS FOR ULTRAFAST PURIFICATION OF HIGH-SALINITY WASTEWATER ASSISTED BY TRACE H2O2 AND PREPARATION METHODS THEREOF

(71) Applicant: GUANGZHOU UNIVERSITY, Guangzhou (CN)

(72) Inventors: Chun HU, Guangzhou (CN); Chang ZHONG, Guangzhou (CN); Weixiang LIAO, Guangzhou (CN); Yumeng WANG, Guangzhou (CN)

(73) Assignee: GUANGZHOU UNIVERSITY, Guangzhou (CN)

(21) Appl. No.: 19/642,612

(22) Filed: Apr. 8, 2026

(30) Foreign Application Priority Data
Apr. 27, 2025 (CN) 202510538511.7

(51) Int. Cl. B01J 27/24; B01J 23/72; B01J 37/00; B01J 37/08; C02F 1/72; C02F 101/34; C02F 101/36; C02F 101/38

(52) U.S. Cl. CPC B01J 27/24; B01J 23/72; B01J 37/0018; B01J 37/0036; B01J 37/082; C02F 1/722; C02F 1/725; C02F 2101/345; C02F 2101/36; C02F 2101/38; C02F 2305/026

(57) ABSTRACT

A catalyst for ultrafast purification of high-salinity wastewater assisted by trace H₂O₂ and a preparation method thereof are provided. The preparation method includes: dispersing biomass silkworm excrement in deionized water, adding a soluble copper salt, and stirring sufficiently to dissolve the soluble copper salt to obtain a suspension A; adding tannic acid to the suspension A, and stirring sufficiently to dissolve the tannic acid to obtain a suspension B; adding urea to the suspension B, stirring sufficiently to dissolve the urea, evaporating a solvent, drying, and grinding to obtain an intermediate product; and placing the intermediate product in flowing nitrogen for calcination, and grinding again to obtain the catalyst.

### CROSS-REFERENCE TO RELATED APPLICATIONS

This application claims priority to the Chinese Patent Application No. 202510538511.7, filed on Apr. 27, 2025, the contents of which are hereby incorporated by reference.

### TECHNICAL FIELD

The present disclosure generally relates to the field of catalyst preparation technology for wastewater degradation, and in particular, to a catalyst for ultrafast purification of high-salinity wastewater assisted by trace H₂O₂ and a preparation method thereof.

### BACKGROUND

In aquatic systems, emerging contaminants (ECs) represent a pollution problem of growing severity. ECs such as active pharmaceutical ingredients (e.g., antibiotics) and endocrine-disrupting chemicals (e.g., bisphenol A (BPA)) pose serious threats to aquatic organisms and human health. In particular, for high-alkalinity wastewater (e.g., wastewater with a mass fraction of salt greater than or equal to 3.5%) generated by various industries such as chemical manufacturing and seawater desalination for drinking water production, the conventional advanced oxidation processes are rendered ineffective by the rapid scavenging of free radicals by high concentrations of salt ions, while also incurring substantial energy consumption.

Therefore, it is necessary to provide a catalyst for ultrafast purification of high-salinity wastewater assisted by trace H₂O₂ and a preparation method thereof.

### SUMMARY

One or more embodiments of the present disclosure provide a preparation method of a catalyst for ultrafast purification of high-salinity wastewater assisted by trace H₂O₂. The preparation method includes (1) dispersing biomass silkworm excrement in deionized water, adding a soluble copper salt, and stirring sufficiently to dissolve the soluble copper salt to obtain a suspension A; (2) adding tannic acid to the suspension A, and stirring sufficiently to dissolve the tannic acid to obtain a suspension B; (3) adding urea to the suspension B, stirring sufficiently to dissolve the urea, evaporating a solvent, drying, and grinding to obtain an intermediate product; and (4) placing the intermediate product in flowing nitrogen for calcination, and grinding again to obtain the catalyst. A calcination temperature is in a range of 500 °C-900 °C, a heating rate for the calcination is in a range of 3 °C/min-7 °C/min, and a holding time for the calcination is in a range of 2 h-5 h.

In some embodiments, a mass-molar ratio of the biomass silkworm excrement to the soluble copper salt is in a range of 0.3 g/mmol-25 g/mmol. In some embodiments, a mass-molar ratio of the biomass silkworm excrement to the soluble copper salt is in a range of 1.6 g/mmol-5 g/mmol.

In some embodiments, a mass ratio of the biomass silkworm excrement to the tannic acid is in a range of 0.5 g/g-10 g/g. In some embodiments, a mass ratio of the biomass silkworm excrement to the tannic acid is in a range of 2.5 g/g-5 g/g.

In some embodiments, a mass ratio of the biomass silkworm excrement to the urea is in a range of 0.06 g/g-5 g/g. In some embodiments, a mass ratio of the biomass silkworm excrement to the urea is in a range of 0.3 g/g-1 g/g.

In some embodiments, a drying temperature in step (3) is in a range of 40 °C-80 °C, and a drying time in step (3) is in a range of 8 h-18 h.

One or more embodiments of the present disclosure further provide a catalyst for ultrafast purification of high-salinity wastewater assisted by trace H₂O₂. The catalyst is prepared by the above-mentioned preparation method.

One or more embodiments of the present disclosure further provide an application of the catalyst for ultrafast purification of high-salinity wastewater assisted by trace H₂O₂ as a Fenton catalyst in degrading organic pollutants in water. The application includes uniformly dispersing the catalyst and H₂O₂ in water containing the organic pollutants.

In some embodiments, the organic pollutants include at least one of BPA, ciprofloxacin (CIP), tetracycline (TC), diphenhydramine (DP), 2,4-dichlorophenoxyacetic acid (2,4-D), or phenytoin (PHT).

### BRIEF DESCRIPTION OF THE DRAWINGS

Embodiments of the present disclosure are further described with reference to the drawings. However, the embodiments in the drawings do not constitute any limitation to the present disclosure. For a person of ordinary skill in the art, other drawings may be obtained according to the following drawings without creative efforts.

FIG. 1 is a scanning electron microscope (SEM) image of a catalyst prepared in Example 1.

FIG. 2 is an X-ray diffraction pattern of the catalyst prepared in Example 1.

FIG. 3 is a diagram illustrating curves showing dependence of degradation effect on degradation time for the catalyst prepared in Example 1 in catalytic degradation of various organic pollutants.

FIG. 4 is a diagram illustrating curves showing dependence of degradation effect on degradation time for the catalyst prepared in Example 1 in catalytic degradation of BPA under different Cl⁻ concentrations.

FIG. 5 is a diagram illustrating curves showing dependence of degradation effect on degradation time for the catalyst prepared in Example 1 in catalytic degradation of the BPA under different H₂O₂ concentrations.

FIG. 6 is an evaluation diagram of cyclic reuse activity of the catalyst prepared in Example 1 for degradation of the BPA.

FIG. 7 is a diagram illustrating degradation rate curves of the catalyst prepared in Example 1 for ultra-high-salinity pharmaceutical wastewater.

### DETAILED DESCRIPTION

The present disclosure is further described in combination with the following embodiments.

The conventional advanced oxidation processes lose effectiveness because high-concentration salt ions react rapidly with free radicals. The heterogeneous catalyst containing cation-π interactions exhibits efficient ECs degradation under low oxidant consumption by enhancing directional interfacial electron transfer, which is attributed to robust cation-x electrostatic forces. The strength of the cation-π interactions depends on the type of cations and the nature of x systems, indicating that the involved surrounding environment can modulate the intensity of the electrostatic field. The interactions between the cations/anions and the x systems influence the strength of the cation-π interactions. Therefore, the coordination of the high-concentration salt ions with the cations and the x systems in the heterogeneous catalyst can generate different catalytic efficiencies by modulating the intensity of the cation-π electrostatic forces. Therefore, in some embodiments of the present disclosure, a heterogeneous catalyst containing the cation-π system is provided, and synergistic coordination of multi-component substances on the surface of the heterogeneous catalyst is utilized to induce charge rearrangement to generate greater electric field energy for the ECs cleavage, enabling low-energy, efficient purification of the high-salinity wastewater.

In some embodiments of the present disclosure, a preparation method of a catalyst for ultrafast purification of high-salinity wastewater assisted by trace H₂O₂ is provided. The preparation method includes: (1) dispersing biomass silkworm excrement in deionized water, adding a soluble copper salt, and stirring sufficiently to dissolve the soluble copper salt to obtain a suspension A; (2) adding tannic acid to the suspension A, and stirring sufficiently to dissolve the tannic acid to obtain a suspension B; (3) adding urea to the suspension B, stirring sufficiently to dissolve the urea, evaporating a solvent, drying, and grinding to obtain an intermediate product; and (4) placing the intermediate product in flowing nitrogen for calcination, and grinding again to obtain the catalyst. A calcination temperature is in a range of 500 °C-900 °C, a heating rate for the calcination is in a range of 3 °C/min-7 °C/min, and a holding time for the calcination is in a range of 2 h-5 h.

The preparation method of the catalyst for ultrafast purification of high-salinity wastewater assisted by trace H₂O₂ is provided in some embodiments of the present disclosure. The preparation method includes the following steps.

(1) Biomass silkworm excrement is dispersed in deionized water, a soluble copper salt is added, and after the mixture is sufficiently stirred to dissolve the soluble copper salt, a suspension A is obtained.

In some embodiments, the soluble copper salt includes copper chloride, copper sulfate, copper nitrate, copper acetate, or the like.

In some embodiments, a mass-molar ratio of the biomass silkworm excrement to the soluble copper salt may be set according to requirements. The mass-molar ratio of the biomass silkworm excrement to the soluble copper salt refers to a ratio of a mass of the biomass silkworm excrement to a mole of the soluble copper salt.

In some embodiments, the mass-molar ratio of the biomass silkworm excrement to the soluble copper salt is in a range of 0.3 g/mmol-25 g/mmol. In some embodiments, the mass-molar ratio of the biomass silkworm excrement to the soluble copper salt is in a range of 1 g/mmol-20 g/mmol. In some embodiments, the mass-molar ratio of the biomass silkworm excrement to the soluble copper salt is in a range of 1 g/mmol-15 g/mmol. In some embodiments, the mass-molar ratio of the biomass silkworm excrement to the soluble copper salt is in a range of 1 g/mmol-10 g/mmol. In some embodiments, the mass-molar ratio of the biomass silkworm excrement to the soluble copper salt is in a range of 1 g/mmol-5 g/mmol. In some embodiments, the mass-molar ratio of the biomass silkworm excrement to the soluble copper salt is in a range of 1 g/mmol-1.6 g/mmol. In some embodiments, the mass-molar ratio of the biomass silkworm excrement to the soluble copper salt is in a range of 1.6 g/mmol-5 g/mmol. In some embodiments, the mass-molar ratio of the biomass silkworm excrement to the soluble copper salt is in a range of 1.6 g/mmol-3 g/mmol. In some embodiments, the mass-molar ratio of the biomass silkworm excrement to the soluble copper salt is 0.3 g/mmol, 1 g/mmol, 1.6 g/mmol, 5 g/mmol, 10 g/mmol, 15 g/mmol, 20 g/mmol, 25 g/mmol, etc.

The suspension A refers to a solid-liquid mixture formed by dispersing the biomass silkworm excrement in an aqueous solution of the soluble copper salt.

(2) Tannic acid is added to the suspension A, and after the mixture is stirred sufficiently to dissolve the tannic acid, a suspension B is obtained.

In some embodiments, a mass ratio of the biomass silkworm excrement to the tannic acid is in a range of 0.5 g/g-10 g/g. In some embodiments, the mass ratio of the biomass silkworm excrement to the tannic acid is in a range of 2 g/g-10 g/g. In some embodiments, the mass ratio of the biomass silkworm excrement to the tannic acid is in a range of 2 g/g-5 g/g. In some embodiments, the mass ratio of the biomass silkworm excrement to the tannic acid is in a range of 2.5 g/g-5 g/g. In some embodiments, the mass ratio of the biomass silkworm excrement to the tannic acid is in a range of 2 g/g-2.5 g/g. In some embodiments, the mass ratio of the biomass silkworm excrement to the tannic acid is 0.5 g/g, 1 g/g, 2 g/g, 2.5 g/g, 5 g/g, 8 g/g, 10 g/g, etc.

The suspension B refers to a solid-liquid mixture formed by dissolving the tannic acid in the suspension A.

(3) Urea is added to the suspension B, after the mixture is stirred sufficiently to dissolve the urea, a solvent is evaporated to obtain a solid, and an intermediate product is obtained after drying and grinding the solid. The solvent refers to the deionized water. The intermediate product refers to solid powder obtained by mixing and dissolving the suspension B with the urea, evaporating the solvent to obtain a solid, and drying and grinding the solid.

In some embodiments, a mass ratio of the biomass silkworm excrement to the urea is in a range of 0.06 g/g-5 g/g. In some embodiments, the mass ratio of the biomass silkworm excrement to the urea is in a range of 1 g/g-4 g/g. In some embodiments, the mass ratio of the biomass silkworm excrement to the urea is in a range of 2 g/g-4 g/g. In some embodiments, the mass ratio of the biomass silkworm excrement to the urea is in a range of 3 g/g-4 g/g. In some embodiments, the mass ratio of the biomass silkworm excrement to the urea is in a range of 0.3 g/g-1 g/g. In some embodiments, the mass ratio of the biomass silkworm excrement to the urea is in a range of 0.5 g/g-1 g/g. In some embodiments, the mass ratio of the biomass silkworm excrement to the urea is 0.06 g/g, 0.3 g/g, 1 g/g, 2 g/g, 3 g/g, 4 g/g, 5 g/g, etc.

In some embodiments, a drying temperature in step (3) is in a range of 40 °C-80 °C. In some embodiments, the drying temperature in step (3) is in a range of 60 °C-80 °C. In some embodiments, the drying temperature in step (3) is in a range of 40 °C-60 °C. In some embodiments, the drying temperature in step (3) is in a range of 40 °C, 50 °C, 60 °C, 70 °C, 80 °C, etc.

In some embodiments, a drying time in step (3) is in a range of 8 h-18 h. In some embodiments, the drying time in step (3) is in a range of 12 h-18 h. In some embodiments, the drying time in step (3) is in a range of 8 h-12 h. In some embodiments, the drying time in step (3) is 8 h, 10 h, 12 h, 14 h, 16 h, 18 h, or the like.

(4) The intermediate product is placed in flowing nitrogen for calcination, and after grinding again, the catalyst is obtained.

In some embodiments, a calcination temperature is in a range of 500 °C-900 °C. In some embodiments, the calcination temperature is in a range of 600 °C-900 °C. In some embodiments, the calcination temperature is in a range of 700 °C-900 °C. In some embodiments, the calcination temperature is in a range of 800 °C-900 °C. In some embodiments, the calcination temperature is 500 °C, 600 °C, 700 °C, 800 °C, 900 °C, or the like.

In some embodiments, a heating rate for the calcination is in a range of 3 °C/min-7 °C/min. In some embodiments, the heating rate for the calcination is in a range of 3 °C/min-5 °C/min. In some embodiments, the heating rate for the calcination is in a range of 5 °C/min-7 °C/min. In some embodiments, the heating rate for the calcination is 3 °C/min, 5 °C/min, 7 °C/min, or the like.

In some embodiments, a holding time for the calcination is in a range of 2 h-5 h. In some embodiments, the holding time for the calcination is in a range of 2 h-4 h. In some embodiments, the holding time for the calcination is in a range of 2 h-3 h. In some embodiments, the holding time for the calcination is 2 h, 3 h, 4 h, 5 h, or the like.

In some embodiments, a flow rate of the flowing nitrogen is in a range of 0.1 L/min-0.3 L/min.

The preparation method of the catalyst according to the embodiments of the present disclosure is simple, has low equipment requirements, and uses the biomass silkworm excrement as the raw material to achieve effective resource utilization of the waste. Meanwhile, the catalyst is a heterogeneous solid catalyst, which facilitates separation and recovery for recycling after the catalytic reaction, and has good continuous cyclic catalytic reaction activity.

In some embodiments of the present disclosure, the catalyst with excellent catalytic degradation performance for the organic pollutants in water is prepared through the preparation method involving a two-step synthesis (i.e., organic complexation and then calcination). The structure of the catalyst mainly includes copper and graphene-like structures connected through Cu—N—C and Cu—O—C bonds, encapsulating zero-valent copper and forming the cation-x electrostatic forces on the surface of the catalyst. During a catalytic degradation reaction, synergistic coordination of the ECs, H₂O₂, and the salts on the surface of the catalyst can induce surface charge rearrangement of the catalyst, enhance chemical adsorption of the ECs and H₂O₂, and generate stronger surface electric field energy. The catalyst exhibits efficient catalytic degradation capability for various ECs with low oxidant consumption, and can effectively and rapidly remove BPA, CIP, TC, DP, 2,4-D, and PHT from the wastewater. A removal rate of the catalyst for BPA and PHT is more than 90% at 5 min. The catalyst also has a good treatment effect on the actual wastewater. After being treated by 30 min, a removal rate of chemical oxygen demand (COD) reaches about 90%. The catalyst also exhibits extremely high salt tolerance. As the salt concentration increases, the catalytic effect gradually enhances, while simultaneously reducing H₂O₂ consumption and improving utilization.

The present disclosure also provides a catalyst for ultrafast purification of high-salinity wastewater assisted by trace H₂O₂. The catalyst is prepared by the above-mentioned preparation method.

The catalyst in some embodiments of the present disclosure can perform catalytic degradation under neutral conditions (e.g., pH=6.0-8.0) without adjusting the pH of the catalytic reaction system.

The present disclosure also provides a method for degrading organic pollutants in water using the catalyst for ultrafast purification of high-salinity wastewater assisted by trace H₂O₂ as a Fenton catalyst. The method includes uniformly dispersing the catalyst and H₂O₂ in water containing the organic pollutants.

In some embodiments, the organic pollutants include at least one of BPA, CIP, TC, DP, 2,4-D, or PHT.

All raw materials used in the embodiments of the present disclosure may be purchased from the market.

### Example 1

A preparation method of a catalyst for ultrafast purification of high-salinity wastewater assisted by trace H₂O₂ includes the following steps.

(1) 2 g of biomass silkworm excrement was dispersed in 50 mL of deionized water, and after stirring and dispersing for 15 min, a first solution was obtained. 2 mmol of copper chloride dihydrate was added to the first solution, and after stirring for 30 min to dissolve the copper chloride dihydrate, a suspension A was obtained.

(2) 1 g of tannic acid was added to the suspension A, and after stirring for 30 min, a suspension B was obtained.

(3) 8 g of urea was added to the suspension B, and after stirring sufficiently to dissolve the urea, a second solution was obtained. The second solution was placed in a water bath to evaporate, then placed in an air-drying oven to dry at a drying temperature of 60 °C for a drying time of 12 h to obtain a pretreated product. The pretreated product was ground uniformly to obtain an intermediate product.

(4) The intermediate product was placed in a quartz crucible, transferred to a tube furnace, and calcined under flowing nitrogen with a calcination temperature of 900 °C, a heating rate for the calcination of 5 °C/min, and a holding time for the calcination of 2 h. After the calcination, the intermediate product was ground again to obtain a Cu—NG@Cu⁰ Fenton catalyst. The catalyst was in the form of black solid powder.

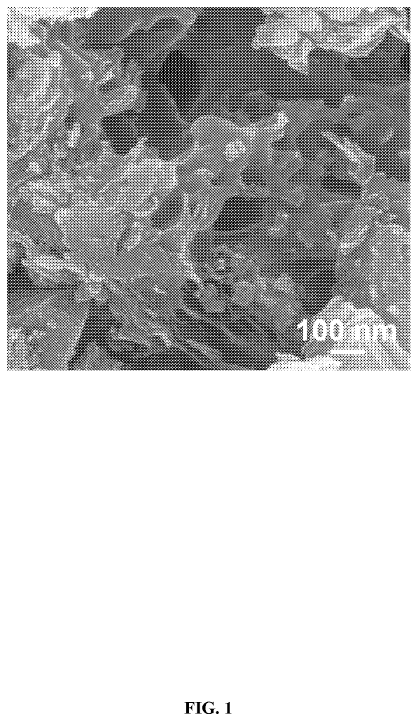

FIG. 1 is a scanning electron microscope (SEM) image of a catalyst prepared in Example 1.

The catalyst prepared in Example 1 was characterized. The SEM image of the catalyst is shown in FIG. 1. As shown in FIG. 1, Cu—NG@Cu⁰ has a porous structure with a pore size of 0.13 μm, and both copper nanoparticles and urea-derived graphitized layers are confined in the pores.

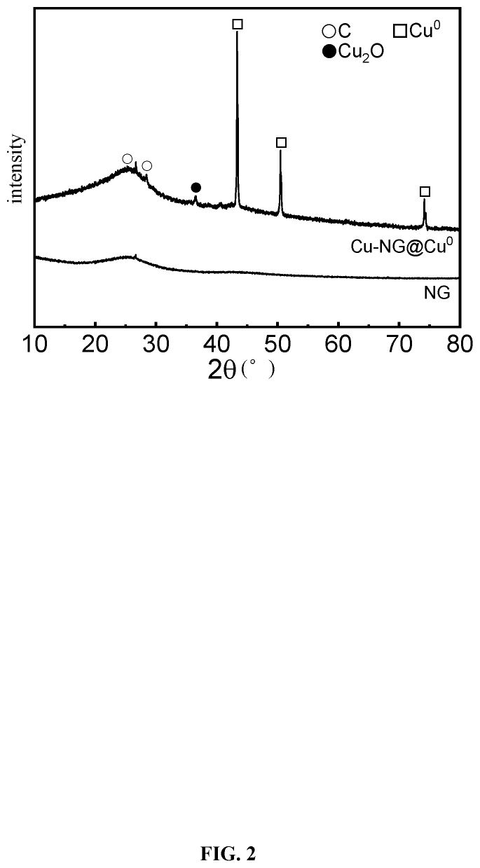

FIG. 2 is an X-ray diffraction (XRD) pattern of the catalyst prepared in Example 1. In FIG. 2, a horizontal coordinate is an X-ray diffraction angle, represented by “2θ”, and a vertical coordinate is intensity.

The XRD pattern of the catalyst is shown in FIG. 2. Comparison with standard cards reveals characteristic diffraction peaks ((111), (200), and (220)) of Cu⁰ and characteristic diffraction peaks of Cu₂O and carbon crystal plane (002).

TABLE 1
Cu-edge EXAFS (Extended X-ray Absorption Fine Structure)
oscillation numerical fitting results for Cu-NG@Cu⁰

| Sample | Shell | R^{a}(Å) | CN^{b} | σ^{2c}(Å²) | ΔE₀^{d}(eV) | R_{f}^{e} |
|---|---|---|---|---|---|---|
| Cu-NG@Cu⁰ | Cu—Cu | 2.540 | 0.1 | 0.00049 | −2.943 | 0.0167 |
| | Cu—O | 1.841 | 1.2 | 0.00049 | −2.943 | |
| | Cu—N | 1.903 | 1.6 | 0.00049 | −2.943 | |
| | Cu—C | 2.964 | 0.6 | 0.00049 | −2.943 | |

Table 1 shows Cu-edge EXAFS oscillation numerical fitting results for the Cu—NG@Cu⁰. The results indicate that an average coordination number of a central Cu atom is 4. The central Cu atom is directly bonded to 1.2 O atoms and 1.6 N atoms in a first coordination shell and an average of 0.6 C atoms in a second coordination shell. Therefore, on the surface of the Cu—NG@Cu⁰, a single-atom Cu is bridged via Cu—O—C and Cu—N—C bonds. The single-atom Cu exhibits the strong Cu-x interaction with the delocalized x orbitals perpendicular to the aromatic ring plane in a nitrogen-doped graphene-like (NG) carbon support.

### Example 2

A method for degrading organic pollutants in water includes the following steps.

0.01 g of the catalyst prepared in Example 1 was added to 50 mL of a simulated solution. A concentration of the organic pollutant in the simulated solution was 20 μmol. 50 μL of a H₂O₂ solution (10 mmol) was simultaneously added to the simulated solution. Continuous stirring degradation was performed under a 35 °C water bath. The concentration of the organic pollutant was measured at different time points.

The organic pollutants were BPA, CIP, TC, DP, 2,4-D, and PHT, respectively.

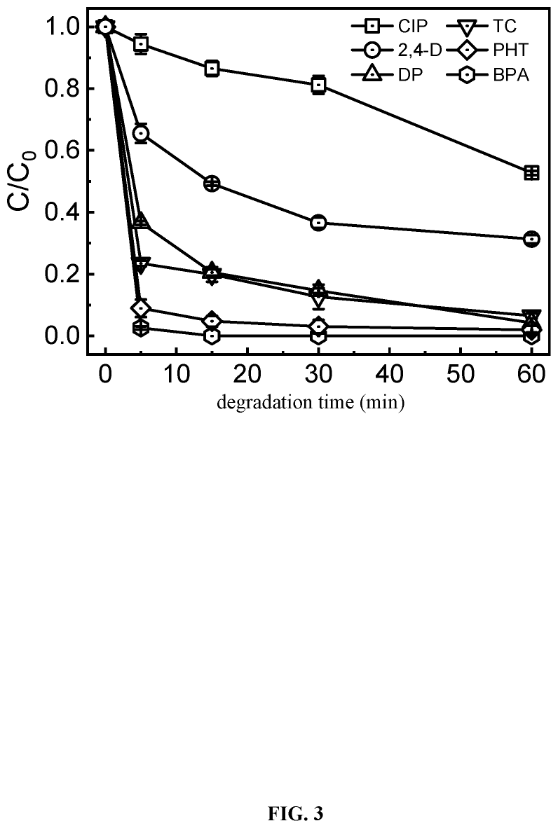

FIG. 3 is a diagram illustrating curves showing dependence of degradation effect on degradation time for the catalyst prepared in Example 1 in catalytic degradation of various organic pollutants. In FIG. 3, an abscissa represents a degradation time, and an ordinate represents a degradation rate of the organic pollutant, expressed as C/C₀. C₀ represents an initial concentration of the organic pollutant. C represents a current concentration of the organic pollutant after a specific degradation time.

The curves representing dependence of the degradation effect on the degradation time for the catalyst prepared in Example 1 in catalytic degradation of various organic pollutants are shown in FIG. 3. As is shown from FIG. 3, within 60 min, degradation rates of the Cu—NG@Cu⁰/H₂O₂ system (a concentration of H₂O₂ is 10 mmol) for 20 μmol of BPA, CIP, TC, DP, 2,4-D, and PHT reach 100%, 47.3%, 93.6%, 95.8%, 68.7%, and 98.1%, respectively.

### Example 3

A method for degrading organic pollutants in water includes the following steps.

0.01 g of the catalyst prepared in Example 1 was added to 50 mL of a BPA solution. A BPA concentration was 40 μmol, and Cl-concentrations were 0, 1 mmol, 10 mmol, and 100 mmol, respectively, in the BPA solution. 50 μL of a H₂O₂ solution was simultaneously added to the BPA solution. Continuous stirring degradation was performed under a 35 °C water bath. The BPA concentration was measured at different time points.

### Example 4

A method for degrading organic pollutants in water includes the following steps.

0.01 g of the catalyst prepared in Example 1 was added to 50 mL of a BPA solution. A BPA concentration was 40 μmol and a Cl-concentration was 100 mmol in the BPA solution. H₂O₂ solutions with final concentrations of 0, 0.2 mmol, 0.5 mmol, 0.8 mmol, and 2 mmol (i.e., after adding the H₂O₂ solutions to the BPA solution containing the Cu—NG@Cu⁰ catalyst, final concentrations of H₂O₂ were 0, 0.2 mmol, 0.5 mmol, 0.8 mmol, and 2 mmol, respectively) were respectively added to the BPA solution. Continuous stirring degradation was performed under a 35 °C water bath. The BPA concentration was measured at different time points.

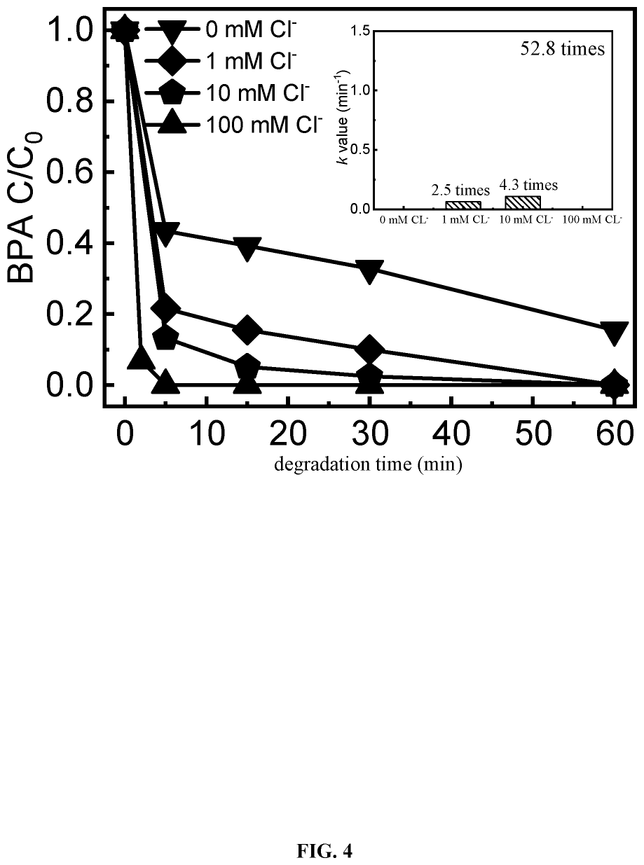

FIG. 4 is a diagram illustrating curves showing dependence of degradation effect on degradation time for the catalyst prepared in Example 1 in catalytic degradation of BPA under different Cl⁻ concentrations. In FIG. 4, an abscissa represents a degradation time, and an ordinate represents a degradation rate of the BPA, which is expressed as C/C₀. C₀ represents an initial concentration of the BPA. C represents a current concentration of the BPA after a specific degradation time. In an inset graph in FIG. 4, an abscissa represents a Cl⁻ concentration and an ordinate represents a k value. The k value refers to a pseudo-first-order reaction rate constant for catalytic degradation of the BPA by the catalyst prepared in Example 1 under different Cl⁻ concentrations. The k value is used to quantify a degradation reaction rate. A larger k value indicates a faster degradation reaction rate.

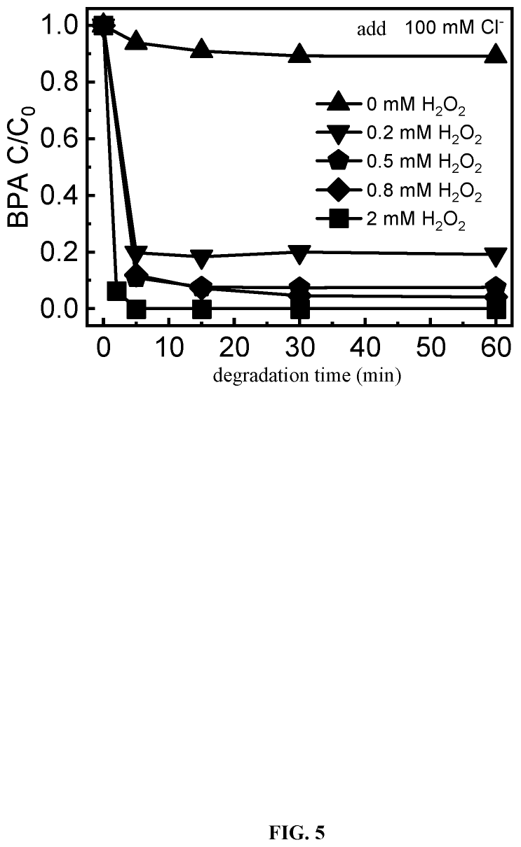

FIG. 5 is a diagram illustrating curves showing dependence of degradation effect on degradation time for the catalyst prepared in Example 1 in catalytic degradation of the BPA under different H₂O₂ concentrations. In FIG. 5, an abscissa represents a degradation time, and an ordinate represents a degradation rate of the BPA, which is expressed by C/C₀. C₀ represents an initial concentration of the BPA, and C represents a current concentration of the BPA after a specific degradation time. Curves representing dependence of degradation effect on degradation time for the Cu—NG@Cu⁰ catalyst prepared in Example 1 in catalytic degradation of the BPA under different Cl⁻ concentrations and different H₂O₂ concentrations are shown in FIG. 4 and FIG. 5, respectively. Under other identical conditions, when an initial concentration of the BPA is 40 μmol, a degradation rate of the BPA increases with an increase in the Cl-concentration. In the presence of 100 mmol Cl⁻, the Cu—NG@Cu⁰ catalyst can completely degrade the BPA within 5 min (as shown in FIG. 4), which is 52.8 times faster than under a condition without Cl⁻. Meanwhile, a utilization rate of H₂O₂ increases by 5 times (as shown in FIG. 5).

### Example 5

A method for degrading organic pollutants in water includes the following steps.

0.01 g of the Cu—NG@Cu⁰ catalyst prepared in Example 1 was added to 50 mL of a BPA solution, a concentration of the organic pollutants in the BPA solution was 20 μmol, and 50 μL of a H₂O₂ solution was added simultaneously to the BPA solution. Continuous stirring degradation was performed under a 35 °C water bath. After stirring for 60 min, the BPA concentration was measured. After the Cu—NG@Cu⁰ catalyst in a reaction system was separated and dried, the dried catalyst was taken to repeat a BPA solution degradation reaction, and a continuous cycle degradation performance of the catalyst was determined.

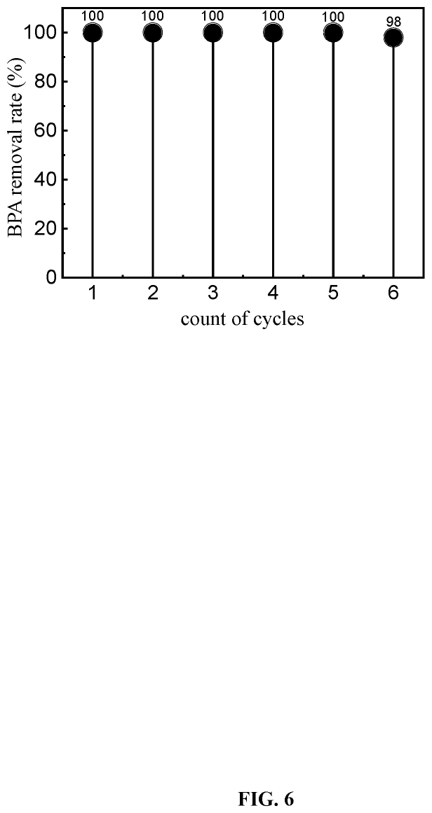

FIG. 6 is an evaluation diagram of cyclic reuse activity of the catalyst prepared in Example 1 for degradation of the BPA. In FIG. 6, an abscissa represents a count of cycles of the Cu—NG@Cu⁰ catalyst (e.g., when the Cu—NG@Cu⁰ catalyst is used n times, the count of the cycles is recorded as (n−1) times, where n is a positive integer greater than 1), and an ordinate represents a BPA removal rate, which represents a removal percentage of the BPA after a specific count of the cycles (which may be expressed as [(C₀−Cₙ)/C₀]*100%, where C₀ represents an initial BPA concentration, and Cₙ represents a BPA concentration after completion of the degradation reaction).

The evaluation diagram of cyclic reuse activity of the Cu—NG@Cu⁰ catalyst prepared in Example 1 for degradation of the BPA is shown in FIG. 6. As shown in FIG. 6, after continuous cycle reactions of the catalyst, the degradation effect on the BPA does not show a significant decline. In six repeated experiments, the BPA removal rate reaches above 95%.

### Example 6

A method for degrading organic pollutants in water includes the following steps.

0.01 g of the Cu—NG@Cu⁰ catalyst prepared in Example 1 was added to 50 mL of an actual ultra-high-salinity pharmaceutical wastewater. Mass concentrations of the salt in the actual ultra-high-salinity pharmaceutical wastewater were 1% and 3.5%, respectively. 50 μL of a H₂O₂ solution was added simultaneously to the actual ultra-high-salinity pharmaceutical wastewater. Continuous stirring degradation was performed under a 35 °C water bath. COD and TOC (Total Organic Carbon) were measured at different time points.

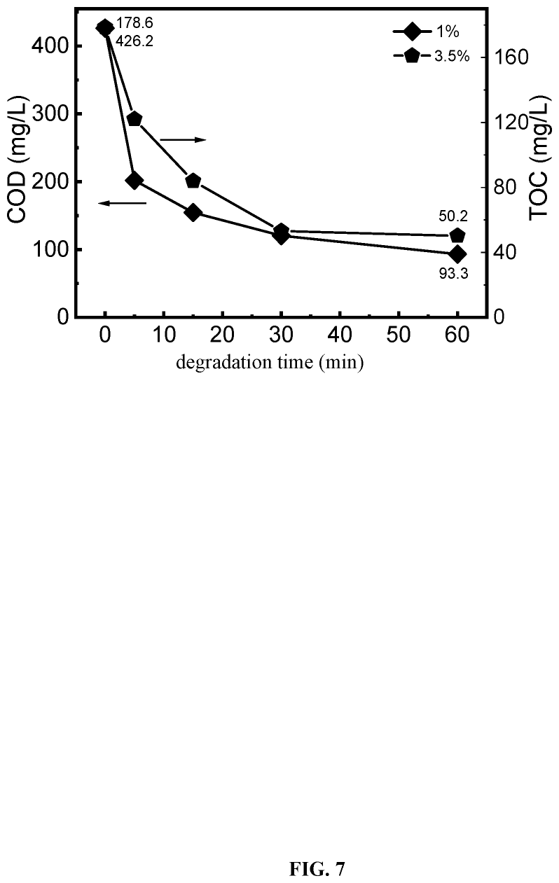

FIG. 7 is a diagram illustrating degradation rate curves of the catalyst prepared in Example 1 for ultra-high-salinity pharmaceutical wastewater. In FIG. 7, an abscissa represents a degradation time, a left ordinate represents COD, and a right ordinate represents TOC.

The degradation rate curves of the Cu—NG@Cu⁰ catalyst for the ultra-high-salinity pharmaceutical wastewater are shown in FIG. 7. Within 60 min, with the assistance of 1.2 mmol H₂O₂, COD of the pharmaceutical wastewater with a mass ratio of salt of 1% is reduced from 426.2 mg/L to 93.3 mg/L, and a removal rate reaches 78.1%. For the pharmaceutical wastewater with a mass ratio of salt of 3.5%, the Cu—NG@Cu⁰ catalyst can also reduce TOC from 178.6 mg/L to 50.2 mg/L within the same time period with the assistance of only 2 mmol H₂O₂. The above results indicate that the Cu—NG@Cu⁰ catalyst has a good application prospect for treating saline/high-salinity wastewater. The catalytic degradation process does not rely on H₂O₂, which is different from a general Fenton reaction. The general Fenton reaction completely relies on the decomposition of H₂O₂ to generate ·OH, requires reaction under strongly acidic conditions (e.g., pH=3), and under high-salinity conditions, a reaction rate sharply declines due to the radical quenching (e.g., a reaction between Cl⁻ with ·OH). However, when the catalyst prepared in some embodiments of the present disclosure is used as a Fenton catalyst, the catalyst does not rely on H₂O₂, can perform catalytic degradation under neutral conditions (e.g., pH=6.0-8.0), does not require adjustment of pH of a catalytic reaction system, and a reaction rate is not limited by high-salinity conditions. The reaction rate even increases with an increase in the concentration of salt (e.g., Cl⁻).

Finally, it should be noted that the above embodiments are merely intended to describe the technical solutions of the present disclosure, rather than to limit the protection scope of the present disclosure. Although the present disclosure is described in detail with reference to the preferred embodiments, persons of ordinary skill in the art should understand that modifications or equivalent replacements may be made to the technical solutions of the present disclosure without departing from the spirit and scope of the technical solutions of the present disclosure.

What is claimed is:

1. A preparation method of a catalyst for ultrafast purification of high-salinity wastewater assisted by trace H₂O₂, comprising:
(1) dispersing biomass silkworm excrement in deionized water, adding a soluble copper salt, and stirring sufficiently to dissolve the soluble copper salt to obtain a suspension A;
(2) adding tannic acid to the suspension A, and stirring sufficiently to dissolve the tannic acid to obtain a suspension B;
(3) adding urea to the suspension B, stirring sufficiently to dissolve the urea, evaporating a solvent, drying, and grinding to obtain an intermediate product; and
(4) placing the intermediate product in flowing nitrogen for calcination, and grinding again to obtain the catalyst; wherein
a calcination temperature is in a range of 500 °C-900 °C,
a heating rate for the calcination is in a range of 3 °C/min-7 °C/min, and
a holding time for the calcination is in a range of 2 h-5 h.

2. The preparation method according to claim 1, wherein a mass-molar ratio of the biomass silkworm excrement to the soluble copper salt is in a range of 0.3 g/mmol-25 g/mmol.

3. The preparation method according to claim 1, wherein a mass ratio of the biomass silkworm excrement to the tannic acid is in a range of 0.5 g/g-10 g/g.

4. The preparation method according to claim 1, wherein a mass ratio of the biomass silkworm excrement to the urea is in a range of 0.06 g/g-5 g/g.

5. The preparation method according to claim 1, wherein a drying temperature in step (3) is in a range of 40 °C-80 °C, and a drying time in step (3) is in a range of 8 h-18 h.

6. A catalyst for ultrafast purification of high-salinity wastewater assisted by trace H₂O₂, wherein the catalyst is prepared according to a preparation method comprising:
(1) dispersing biomass silkworm excrement in deionized water, adding a soluble copper salt, and stirring sufficiently to dissolve the soluble copper salt to obtain a suspension A;
(2) adding tannic acid to the suspension A, and stirring sufficiently to dissolve the tannic acid to obtain a suspension B;
(3) adding urea to the suspension B, stirring sufficiently to dissolve the urea, evaporating a solvent, drying, and grinding to obtain an intermediate product; and
(4) placing the intermediate product in flowing nitrogen for calcination, and grinding again to obtain the catalyst; wherein
a calcination temperature is in a range of 500 °C-900 °C,
a heating rate for the calcination is in a range of 3 °C/min-7 °C/min, and
a holding time for the calcination is in a range of 2 h-5 h.
